(19) United States
(12) Patent Application Publication
(10) Pub. No.: US 2002/0163148 A1
(43) Pub. Date: Nov. 7, 2002

(54) Miniburro

(76) Inventors: Michael James McDonough, Monroe, LA (US); Ronald Conway Kinard, Monroe, LA (US)

Correspondence Address: K & M Enterprises, P.O. Box 6112, Monroe, LA, 71211, US

(21) Appl. No.: 09/877,975

(22) Filed: Jan. 24, 2002

Related U.S. Application Data
(60) Provisional application No. 60/194,783, filed on Jun. 8, 2000.

(51) Int. Cl. B62B 1/10

(52) U.S. Cl. 280/47.26

(57) ABSTRACT

The “mini burro” is unique in that it is optionally pulled by hand or by mechanical device such as a lawn tractor, 3, 4, or 6 wheel ATV. The hand pull handle folds neatly out of the way when the “mini burro” is being pulled by a mechanical device. The tongue, which is used only when being pulled by a mechanical device, slides underneath and is pinned in place out of the way when being pulled by the hand pull handle. The design is such that the weight on the “mini burro” is transferred to the axles thus making it very easy to pull. The “mini burro” is light weight (40 lbs.) yet it has a carry capacity of 450 lbs.

The “miniburro” is a small, two-wheeled cart type device designed to be maneuvered by either of two methods; a manual fold down pull handle, or a retractable tailoring tongue to be attached to a vehicle such as an all-terrain vehicle or riding lawnmower or small tractor. The “miniburro” is made of square steel tubing, welded and or pinned together with poly hi-impact wheels.

To construct the “miniburro”, one must use several pieces of ¾ inch 16 gauge square tubing, some pieces of ¾ inch by 3/16 inch flat steel, two pieces of ¼ inch by 4 inch steel plate, one piece of 1 inch by 36 inch square tubing, one piece of 1¼ inch by 18 inch square tubing, a bending device, a welding machine, two grade 8 bolts with flat washers and self-locking nuts, three ¼ inch clevis pins, and one ½ inch drop pin. These items are assembled by bend a rectangular shape 24 inches by 48 inches, welding the joint of it then bending the opposite long ends upward to create a cradle shape. A hole is drilled in opposite sides of the upward bent portion to facilitate the attachment of the manual pulling handle with two clevis pins. To create an open lattice type floor structure and to add strength to the cradle, ¾ inch by 3/16 inch flat steel is welded across the frame in five (5) places approximately equal distance apart, and two pieces of the same material is welded length-wise and at each joint with the cross members.

The manual pulling handle is bent from the same square tubing into a “U” shape with holes drilled in each of the ends on the open side of the “U”. The clevis pins go through these holes into the holes on the cradle allowing the manual pulling handle to be extended or folded depending on the current need.

At the mid-point on each side of the long axis of the cradle, a piece of ¼ inch by 4 inch steel plate is welded vertically and a ½ inch hole is drilled in the lower end to allow the attachment of the poly wheels using grade 8 bolts as axles with flat washers for spacing and a self-locking nut for securing same.

The unique design feature of the “miniburro” is the attachment of a retractable draw-bar or hitch tongue carried under the cradle in a tube of 1¼ inch by 18 inch square tubing with a ¼ inch hole drilled through to allow the use of a ¼ clevis pin to lock the tongue in a retracted or extended position. The tongue is made of 1 inch 16 gauge square tugging 3 feet long. This tongue has two holes drilled, one toward each end to allowing pinning either in the stored or extended position. Also at one end is drilled a ½ inch hole from top to bottom to allow the placing of a ½′ by 3 inch drop pin attaching the “miniburro” to a towing vehicle of some type.

### DRAWING VIEWS

FIG. 1 of the attached drawing depicts a top view of the complete “miniburro” showing the rectangular shape of the cradle with all dimensions marked. Also shown in the right side of the view is the storage tube for the retractable towing tongue. A close look shows the folded manual pulling handle and the pin locations for securing it to the frame, which also serve as pivot points when the handle is extended.

FIG. 2 shows a side view of the completed “miniburro” depicting the upward thrust of the cradle, the attached wheels, and the folded manual pulling handle that also serves as side rails when unit is being towed using the retractable towing tongue.

FIG. 3 depicts the retractable towing tongue, its size, and the location of the drilled hole for the ½ inch by 3-inch drop pin to attach the “miniburro” to a towing vehicle.

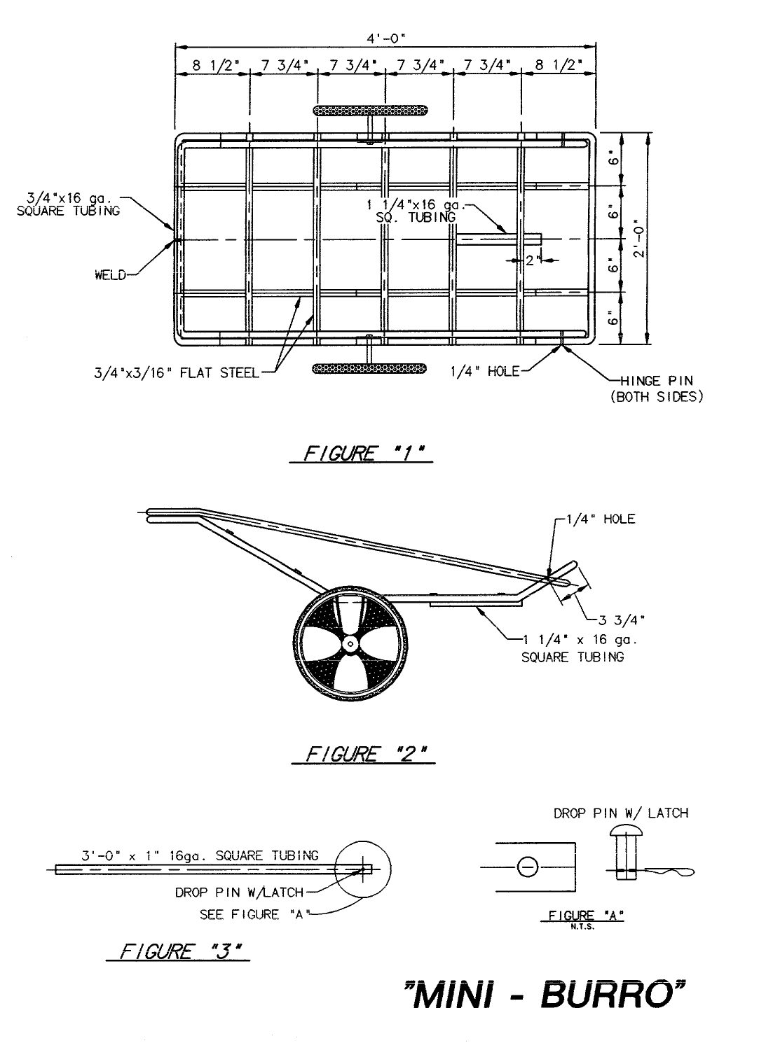

FIG. A (not to scale), shows a larger view of the drilled hole in the towing tongue and one type of drop pin with a latch pin for attaching unit to a towing vehicle.

1. We claim that our retractable towing tongue is a unique design feature not found on any other cart type device designed for utility use.

2. We further claim that the combination of manual pull and vehicular towing capability is also unique in the field.
